(19) United States
(12) Patent Application Publication
(10) Pub. No.: US 2016/0086175 A1
(43) Pub. Date: Mar. 24, 2016

(54) PEER-TO-PEER TRANSACTION SYSTEM

(71) Applicant: QUALCOMM Incorporated, San Diego, CA (US)

(72) Inventors: Keir FINLOW-BATES, Kangasala (FI); Koushik ANNAPUREDDY, Tampere (FI)

(21) Appl. No.: 14/492,624

(22) Filed: Sep. 22, 2014

(51) Int. Cl. G06Q 20/40; H04L 9/14; H04L 29/08

(52) U.S. Cl. CPC G06Q 20/401; H04L 67/104; H04L 67/141; H04L 9/14; H04L 2209/24; G06Q 2220/10

(57) ABSTRACT

Disclosed are implementations that include sending to a P2P system, by a first device associated with a first party, a request to obtain use rights for a property belonging to a second party, the first device further associated with a first network address and with a first digital key pair, and the property associated with a second device associated with a second network address and a second digital key pair. The request is processed with the private key of the first device and includes payment data representative of required number of credits to transfer to the second party, the request further including time data representative of a requested starting time and time duration at which use of the property by the first party is to occur. The method further includes communicating, subsequent to sending of the request, with the second device in order to access, by the first party, the property.

### BACKGROUND

Some entities, e.g., hotels, have implemented a check-in system that does not require a reception. Instead, upon paying by credit card through a web site, a PIN code is sent to a user's phone (or e-mail), which allows the user to enter the hotel room on the day of the booking. Such a check-in system, however, still requires a web browser, the credit card banking infrastructure and a mobile phone for receiving texts or e-mails. If either the booking server or the payment center is down, the check-in process cannot be completed.

### SUMMARY

In some variations, an example method is disclosed. The method includes sending to a peer-to-peer system, by a first network device associated with a first party, a request to obtain use rights for a property belonging to a second party, the first network device is further associated with a first network address and with a first private-public digital key pair, and the property is associated with a second network device that is associated with a second network address and a second private-public digital key pair. The request is processed with the private key of the first network device and includes payment data representative of a required number of commercial-valued credits to transfer to the second party associated with the second network device, with the request further including time data representative of a requested starting time and time duration at which use of the property by the first party associated with the first network device is to occur. The method further includes communicating, subsequent to sending of the request, with the second network device associated with the property in order to access, by the first party, the property.

Embodiments of the method may include at least some of the features described in the present disclosure, including one or more of the following features.

Communicating with the second network device associated with the property may include establishing a communication link with the second network device, receiving, by the first network device, a message comprising a challenge transmitted form the second network device associated with the property, sending to the second network device a reply message responsive to the challenge with the reply message being processed with the private key of the first network device, and in response to a determination that the required number of commercial-valued credits was transferred to the second party associated with the second network device and that the reply message decrypted with the public key of the first network device includes a proper response to the challenge, accessing the property belonging to the second party.

Accessing the property belonging to the second party may include accessing one of, for example, a hotel room, a vehicle, a parking meter, an air-plane seat, a theater, a locker, and/or another time-accessible good or service.

The determination that the reply message decrypted with the public key of the first network device includes the proper response to the challenge may include a determination that content of the reply message, encrypted using the private key of the first network device and decrypted at the second network device using the public key of the first network device obtained by the second network device, matches the challenge included in the message sent by the second network device.

The message sent by the second network device may include a nonce challenge encrypted with the private key of the second network device.

Establishing the communication link with the second network device may include establishing the communication link with the second network device according to a near-field communication protocol when the first network device is within range of the second network device.

Establishing the communication link with the second network device may include establishing the communication link with the second network device according to a non-near-field communication protocol, with the non-near-field communication protocol including one or more of, for example, a WLAN-based communication protocol, and/or a WWAN-based communication protocol.

Sending the request to the peer-to-peer system may include communicating the request to one or more network devices of the peer-to-peer system maintaining transaction ledger data for commercial transactions on the peer-to-peer system, the one or more network devices maintaining the transaction ledger data configured to record the transfer of the required number of commercial-valued credits included in the request to the second party associated with the second network device.

The method may further include performing verification operations, by one or more additional network devices of the peer-to-peer system, on unprocessed transaction ledger data stored at the one or more network devices maintaining the transaction ledger data. Performing the verification operations may include determining whether the requested starting time and the time duration, indicated in the request sent by the first device, at which use of the property by the first party is to occur is available for use.

The required number of commercial-valued credits included in the request may include one or more of, for example, data representative of a required number of Bitcoins, and/or data representative of a required number of altcoins.

The method may further include exchanging one or more communications with a third network device associated with a third party, the third network device being associated with a third network address and a third private-public digital key pair, and the first network device being associated with another property. The method may also include determining at the first network device, based on the one or more communications exchanged with the first network device and based on another request previously sent by the third network device to the peer-to-peer system, whether to provide the third party associated with the third network device access to the other property associated with the first network device, with the other request sent to the peer-to-peer system by the third network device being processed with the private key of the third network device and may include another payment data representative of another required number of commercial-valued credits to transfer to the first party associated with the first network device, with the request further including another time data representative of another requested starting time and time duration at which use of the other property by the third party associated with the third network device is to occur.

In some variations, a mobile device is provided that includes one or more processor-based devices, and storage media including computer instructions. The computer instructions, when executed on the one or more processor-based devices, cause operations including sending to a peer-to-peer system, by the mobile device, a request to obtain use rights for a property, with the mobile device being associated with a first network address, with a first private-public digital key pair, and with a first party. The property belongs to a second party and is associated with a second mobile device associated with a second network address and with a second private-public digital key pair. The request is processed with the private key of the mobile device and includes payment data representative of a required number of commercial-valued credits to transfer to the second party associated with the second mobile device, and further includes time data representative of a requested starting time and time duration at which use of the property by the first party associated with the mobile device is to occur. The computer instructions cause further operations including communicating, subsequent to sending of the request, with the second mobile device associated with the property in order to access, by the first party, the property.

Embodiments of the mobile device may include at least some of the features described in the present disclosure, including at least some of the features described above in relation to the method.

In some variations, an apparatus is provided. The apparatus includes means for sending to a peer-to-peer system, by the apparatus associated with a first party, a request to obtain use rights for a property belonging to a second party, the apparatus further associated with a first network address and with a first private-public digital key pair, and the property associated with a second network device that is associated with a second network address and a second private-public digital key pair. The request is processed with the private key of the apparatus and includes payment data representative of a required number of commercial-valued credits to transfer to the second party associated with the second network device, with the request further including time data representative of a requested starting time and time duration at which use of the property by the first party associated with the apparatus is to occur. The apparatus further includes means for communicating, subsequent to sending of the request, with the second network device associated with the property in order to access, by the first party, the property.

Embodiments of the apparatus may include at least some of the features described in the present disclosure, including at least some of the features described above in relation to the method and the device.

In some variations, a processor-readable media programmed with a set of instructions executable on one or more processor-based devices is disclosed. The set of instructions, when executed, causes operations including sending to a peer-to-peer system, by a first network device associated with a first party, a request to obtain use rights for a property belonging to a second party, the first network device further associated with a first network address and with a first private-public digital key pair, and the property is associated with a second network device that is associated with a second network address and a second private-public digital key pair. The request is processed with the private key of the first network device and includes payment data representative of a required number of commercial-valued credits to transfer to the second party associated with the second network device, with the request further including time data representative of a requested starting time and time duration at which use of the property by the first party associated with the first network device is to occur. The set of instructions causes further operations including communicating, subsequent to sending of the request, with the second network device associated with the property in order to access, by the first party, the property.

Embodiments of the processor-readable media may include at least some of the features described in the present disclosure, including at least some of the features described above in relation to the method, the device, and the apparatus.

In some variations, another method is disclosed. The other method includes exchanging, by a second network device associated with a property belonging to a second party, one or more communications with a first network device associated with a first party, with the first network device being associated with a first network address and with a first private-public digital key pair, and with the second network device being associated with a second network address and a second private-public digital key pair. The other method further includes determining at the second network device, based on the one or more communications exchanged with the first network device and based on a request previously sent by the first network device to a peer-to-peer system comprising at least the first network device and the second network device, whether to provide the first party associated with the first network device access to the property, with the request sent to the peer-to-peer system being processed with the private key of the first network device and including payment data representative of a required number of commercial-valued credits to transfer to the second party associated with the second network device, the request further including time data representative of a requested starting time and time duration at which use of the property by the first party associated with the first network device is to occur.

Embodiments of the other method may include at least some of the features described in the present disclosure, including at least some of the features described above in relation to the first method, the mobile device, the apparatus, and the processor-readable media, as well as one or more of the following features.

Exchanging the one or more communications with the first network device may include receiving an initiating communication to establish a communication link with the first network device, transmitting to the first network device, by the second network device, a message comprising a challenge, and receiving at the second network device a reply message, transmitted form the first network device, responsive to the challenge, the reply message processed with the private key of the first network device.

Determining whether to provide the first party access to the property may include providing the first party with access to the property in response to a determination that the required number of commercial-valued credits was transferred to the second party associated with second network device and that the reply message decrypted with the public key of the first network device includes a proper response to the challenge.

Providing the first party with access to the property may include sending by the second network device a signal to unlock a lock that is restricting access to the property.

The message transmitted to the first network device may include a nonce challenge encrypted with the private key of the second network device.

Receiving the initiating communication to establish the communication link with the first network device may include receiving the initiating communication to establish the communication link with the second network device according to a near-field communication protocol when the first network device is within range of the second network device.

Receiving the initiating communication to establish the communication link with the first network device may include receiving the initiating communication to establish the communication link with the second network device according to a non-near-field communication protocol. The non-near-field communication protocol may include one or more of, for example, a WLAN-based communication protocol, and/or a WWAN-based communication protocol.

The property belonging to the second party may include one of, for example, a hotel room, a vehicle, a parking meter, an air-plane seat, a theater, a locker, and/or another time-accessible good or service.

The request previously sent to the peer-to-peer system may include a transaction request communicated to one or more network devices, of the peer-to-peer system, maintaining transaction ledger data for commercial transactions on the peer-to-peer system, with the one or more network devices maintaining the transaction ledger data being configured to record the transfer of the required number of commercial-valued credits included in the request to the second party associated with the second network device.

In some variations, an additional mobile device is disclosed. The additional mobile device includes one or more processors, and storage media comprising computer instructions. The computer instructions, when executed on the one or more processors, cause operations including exchanging, by the additional mobile device associated with a property belonging to a second party, one or more communications with another network device associated with a first party, with the other mobile device further being associated with a first network address and with a first private-public digital key pair, and with the additional mobile device being associated with a second network address and a second private-public digital key pair. The computer instructions cause further operations including determining at the additional mobile device, based on the one or more communications exchanged with the other mobile device and based on a request previously sent by the other mobile device to a peer-to-peer system comprising at least the additional mobile device and the other mobile device, whether to provide the first party associated with the other mobile device access to the property, with the request sent to the peer-to-peer system being processed with the private key of the other mobile device and including payment data representative of a required number of commercial-valued credits to transfer to the second party associated with the additional mobile device, the request further including time data representative of a requested starting time and time duration at which use of the property by the first party associated with the other mobile device is to occur.

Embodiments of the additional mobile device may include at least some of the features described in the present disclosure, including at least some of the features described above in relation to the methods, the first mobile device, the apparatus, and the processor-readable media.

In some variations, an additional apparatus is disclosed. The additional apparatus includes means for exchanging, by the additional apparatus associated with a property belonging to a second party, one or more communications with a first network device associated with a first party, with the first network device further being associated with a first network address and with a first private-public digital key pair, and with the apparatus being associated with a second network address and a second private-public digital key pair. The additional apparatus further includes means for determining at the apparatus, based on the one or more communications exchanged with the first network device and based on a request previously sent by the first network device to a peer-to-peer system including at least the first network device and the apparatus, whether to provide the first party associated with the first network device access to the property, with the request sent to the peer-to-peer system being processed with the private key of the first network device and including payment data representative of a required number of commercial-valued credits to transfer to the second party associated with the apparatus, the request further including time data representative of a requested starting time and time duration at which use of the property by the first party associated with the first network device is to occur.

Embodiments of the additional apparatus may include at least some of the features described in the present disclosure, including at least some of the features described above in relation to the methods, the mobile devices, the first apparatus, and the processor-readable media,

In some variations, additional processor readable media programmed with a set of instructions executable on one or more processor-based devices is disclosed. The set of instructions, when executed, causes operations including exchanging, by a second network device associated with a property belonging to a second party, one or more communications with a first network device associated with a first party, with the first network device further being associated with a first network address and with a first private-public digital key pair, and with the second network device being associated with a second network address and a second private-public digital key pair. The set of instructions causes, when executed, further operations including determining at the second network device, based on the one or more communications exchanged with the first network device and based on a request previously sent by the first network device to a peer-to-peer system comprising at least the first network device and the second network device, whether to provide the first party associated with the first network device access to the property, wherein the request sent to the peer-to-peer system is processed with the private key of the first network device and includes payment data representative of a required number of commercial-valued credits to transfer to the second party associated with the second network device, the request further including time data representative of a requested starting time and time duration at which use of the property by the first party associated with the first network device is to occur.

Embodiments of the additional processor readable media may include at least some of the features described in the present disclosure, including at least some of the features described above in relation to the methods, the devices, the apparatus, and the first processor-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more items and/or conditions in addition to the stated item and/or condition.

As used herein, a mobile device or station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, tablet devices, etc., which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, or by some other name.

Other and further objects, features, aspects, and advantages of the present disclosure will become better understood with the following detailed description of the accompanying drawings.

### BRIEF DESCRIPTION OF THE DRAWING

FIG. 1 is a schematic diagram is shown of an operating environment that includes a peer-to-peer (“P2P”) system/network to facilitate performance of transactions between two or more parties associated with two or more devices of the P2P system.

FIG. 2 is a block diagram of an example communication device.

FIG. 3 is a signal diagram illustrating example operations performed and messages/communications exchanged in performing an example transaction process between two individual devices of a P2P system/network.

FIG. 4 is a schematic diagram of an example request message.

FIG. 5 is a flowchart of an example procedure generally performed at a first, requesting, network device of a P2P system to acquire use rights of a property associated with another, second, network device.

FIG. 6 is a flowchart of an example procedure, generally performed at a second, receiving, network device of a P2P system, to enable two parties to transact for acquisition of use rights of a property owned by the party associated with the second, receiving network device.

FIG. 7 is a schematic diagram of an example computing system.

Like reference symbols in the various drawings indicate like elements.

### DETAILED DESCRIPTION

Described herein are methods, systems, devices, computer readable media, and other implementations, including an implementation in which a first network device (having a first network address) associated with a first party sends to the peer-to-peer system/network (implementing a digital currency system) a request to obtain use rights for a property belonging to a second party, with the property (e.g., a hotel room, a car, any other time-based good or service) associated with a second network device associated with a second network address. The request is processed (e.g., encrypted) with a private key of the first network device, and includes payment data representative of a required number of commercial-valued credits (e.g., bitcoins, altcoin, or any other type of digital currency system) to transfer to the second party account associated with the second network device, and also time data representative of a requested starting date/time and duration at which use of the property by the first party associated with the first network device is to occur. Subsequent to sending of the request, the first network device communicates with the second network device associated with the property in order to access, by the first party, the property.

In some embodiments, communication between the first and second network devices includes establishing a communication link between the first network device and the second network device (e.g., a near-field communication link, a direct or indirect WLAN or WWAN link, etc.) receiving a message comprising a challenge (e.g., a nonce, which generally refers to some arbitrary value that is used only once) transmitted form the second network device associated with the property, and sending to the second network device a reply message, processed (e.g., encrypted) with the private key of the first network device, responsive to the challenge. In such embodiments, in response to a determination that the required number of commercial-valued credits was transferred to the second party and that the reply message (decrypted with a public key of the first network device obtained by the second network device) includes a proper response to the challenge (and, in some embodiments, that the current time matches the period defined by the starting date/time and duration specified in the request), the property belonging to the second party can be accessed by the first party.

The implementations described herein may thus provide a reservation/booking solution using a lock, or some other type of barrier (e.g., a gate or turnstile to restrict access) connected to a network and a distributed peer-to-peer reservation system that is based on payment of electronic/digital currencies (e.g., bitcoin, altcoin, some other digital currency). By its distributed nature the service can be provided to, and shared by, different rental companies, and there is no single point of failure. The same system could also work as a ticketing system for public transport, parking meters, air plane tickets, car rental, cinemas or the theatre, property lockers, safes, and other booking systems. Such a peer-to-peer-based system can avoid the need for a credit card system, and can allow anyone with a communication device to use the system. Such a system does not have a single point of failure. Implementations of an example system may include: a) a set of locks, one per service or rental property, each including a lock mechanism or barrier connected to, or in communication with, a network device with its own network address, b) instances of a “key” application using asymmetric key cryptography, c) a transaction ledger, which resides in a peer-to-peer system on one or more of devices defining the peer-to-peer system, and constitutes a validated record of the transactions that have taken place between requesting addresses (i.e., “key” addresses) and property “lock” addresses, and d) verification units, which validate the ledger as transaction records are added to it.

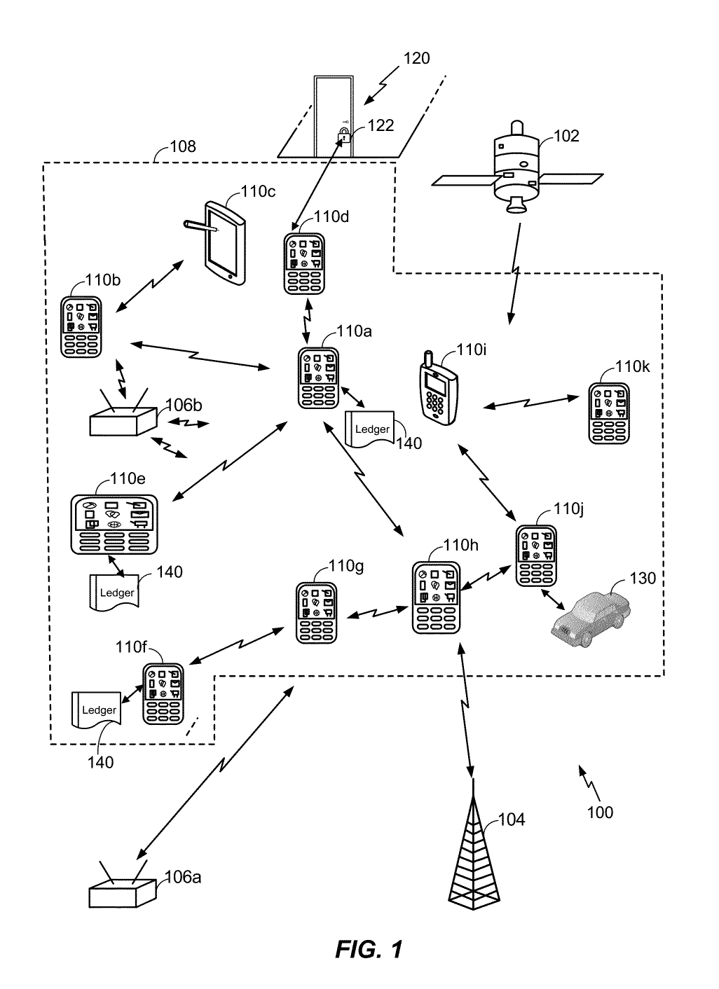

Thus, with reference to FIG. 1, a schematic diagram is shown of an operating environment 100 that includes a peer-to-peer system 108 (also referred to as a “P2P” system or network) to facilitate performance of transactions between two or more parties associated with two or more devices of the P2P system 108. A P2P system generally does not have a central server that controls operation of the system, but rather each device, such as any of the devices 110a-k of the network, can establish communication links with one, some, or all of the other devices in the system, and is configured to serve as a client or server for any of those other devices, allowing those other devices access to its resources. For example, each of the devices 110a-k of the P2P system 108 may maintain a transaction ledger used in implementation of a digital currency system, and each of the devices 110a-k may perform ledger verification operations (e.g., “mining” operations). Each of the devices 110a-k may be a mobile or stationary device with one or more transceivers configured to establish communications links according to one or more communication protocols (e.g., near-field protocols, such as Bluetooth® wireless technology, or Zigbit, WLAN protocols, such as a WiFi protocol according to IEEE 802.11k standard, WWAN protocols, etc.)

The devices 110a-k may, in some embodiments, be configured to implement a P2P system for the purposes of establishing a digital currency system similar to bitcoin, altcoin, etc. Each of the devices may also be a node of some other network communication (e.g., any of the devices may belong to one or more WWAN or WLAN networks) which may exist independently of the P2P system 108. For example, any of the devices 110a-k and/or access points (e.g., access point 106b) may be part of, and connected to, a LAN system, a WAN system, a WLAN system, a WWAN system, etc. The connectivity of any of these devices to a wireless or wired network may enable formation of a P2P system implementing a digital currency system.

As further shown in FIG. 1, the operating environment 100 may include a Local Area Network Wireless Access Points (LAN-WAP) 106a and 106b that may be used for wireless voice and/or data communication with one or more of the devices 110a-k. In some embodiments, the LAN-WAP 106a-b may also be utilized, in conjunction with one or more other access points, as independent sources of position data, e.g., through implementation of multilateration-based procedures based, for example, on time of arrival techniques. The LAN-WAPs 106a-b can be part of a Wireless Local Area Network (WLAN), which may operate in buildings and perform communications over smaller geographic regions than a WWAN. Additionally in some embodiments, either of the LAN-WAPs 106a-b could also be pico or femto cells. In some embodiments, the LAN-WAPs 106a-b may be part of, for example, WiFi networks (802.11x), cellular piconets and/or femtocells, Bluetooth® wireless technology Networks, etc. Although two (2) LAN-WAP access points are depicted in FIG. 1, any number of such LAN-WAP's may be used, and, in some embodiments, the operating environment 100 may include no LAN-WAPs access points at all. Furthermore, the LAN-WAPs 106a-b depicted in FIG. 1 may be moveable nodes, or may be otherwise capable of being relocated.

As further shown in FIG. 1, the operating environment 100 may also include, in some embodiments, at least one Wide Area Network Wireless Access Point (WAN-WAP) 104, which may be used for wireless voice and/or data communication, and may also serve as another source of independent information through which one or more of the devices 110a-k in the P2P system 108 may determine its position/location. The WAN-WAP 104 may be part of wireless wide area network (WWAN), which may include cellular base stations, and/or other wide area wireless systems, such as, for example, WiMAX (e.g., 802.16). A WWAN may include other known network components which are not shown in FIG. 1. Typically, a WAN-WAP, such as the WAN-WAP 104, may operate from fixed positions, and provide network coverage over large metropolitan and/or regional areas. Although only one (1) WAN-WAP is illustrated in FIG. 1, any number of such WAN-WAPs may be used. In some embodiments, the operating environment 100 may include no WAN-WAPs at all. Additionally, the WAN-WAP 104 depicted in FIG. 1 may be a moveable node, or may otherwise be capable of being relocated.

Thus, communication to and from one or more of the mobile devices 110a-k of the P2P system 108 (to exchange data with one or more access points, enable voice communication and position determination of devices of the P2P system 108, etc.) may be implemented, in some embodiments, using various wireless communication networks such as a wide area wireless network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may also be implemented, at least in part, using an IEEE 802.11x network, and a WPAN may be a Bluetooth® wireless technology network, an IEEE 802.15x, or some other type of network. The techniques described herein may also be used for any combination of WWAN, WLAN and/or WPAN.

In some embodiments, and as further depicted in FIG. 1, one or more of the devices 110a-k of the P2P system 108 may also be configured to at least receive information from a Satellite Positioning System (SPS) 102, which may be used as an independent source of position information for the one or more of the devices 110a-k of the system 108. Although only one (1) satellite 102 is illustrated in FIG. 1, any number of such satellites may be used. Devices configured to receive satellite communications may include one or more dedicated SPS receivers specifically designed to receive signals for deriving geo-location information from the SPS satellites.

As noted, each of the devices 110a-k of the P2P system 108 is configured to facilitate transactions between parties associated with the respective devices, e.g., a transaction to acquire use rights of properties owned by various parties. Thus, for example, and as will be described in greater details below, when a party associated with a first one of the devices 110a-k of the example P2P system 108 (such a device is associated with a first network address and with a first private-public digital key pair) wishes to obtain use rights of a property (e.g., temporary use of a room, such as a hotel room 120 depicted in FIG. 1, or temporary use of a car, such as a car 130 that is also depicted in FIG. 1) owned by a second party associated with a second device of the P2P system 108 (the second device being associated with a second network address and a second private-public key pair), the first device sends to a peer-to-peer system a request to obtain use rights for the property belonging to the second party. The request sent by the first device of the P2P system is generally processed with the private key of the first device and includes payment data representative of a required number of commercial-valued credits to transfer to the second party associated with the property and the second network device (e.g., identified by the network address for the second device, as specified in the request). The request generally also includes time data representative of a requested starting time and time duration at which use of the property by the first party associated with the first network device is to occur. The request may be timestamped to indicate the time at which the request was made. Once the transaction is processed (e.g., the second party and/or device can confirm that the required payment of digital currency was made, that a device communicating with the second device is in fact the first device that sent the transaction request, and/or that the current time falls within the period defined by the start time and duration specified in the request), the second device can be used to control/enable (e.g., unlock a lock such as a lock 122 of the property 120) access to the property in question. It is to be noted that in some embodiments, a network device can either be integrated/incorporated into the lock or other components of the property (e.g., a network device would then be part of the property rather than exist as an independent mobile device), be coupled to the property via some dedicated connectivity port at the property, or it may establish a wireless communication link (e.g., via respective transceivers at the property and at the network device) through which control signal(s) may be communicated to enable and control access to the property.

In order to establish a digital currency system, the P2P system 108 needs to implement, e.g., at one or more of the individual devices 110a-k constituting the system 108, a transaction ledger to enable transactions to be processed so that the currency balances associated with a first and second transacting parties (with the first party seeking to temporarily use, or rent, a property belonging to the second party) can be updated in a financial secure way that maintains the integrity of the transactional framework underpinning the implementations described herein. The transaction ledger residing in the peer-to-peer network constitutes a validated record of the digital currency transactions that have taken place between parties of the P2P system. In the embodiments described herein, the transaction ledger can provide a trusted record reflecting the transfer by a first party to a second party of an agreed-upon amount of digital currency for use of a property owned by the second party. The transaction records made in the P2P system 108 are generally cryptographic transactions, e.g., cryptographic transactions implemented through private-public key encryption processes. Thus, in some embodiments, a first transacting party provides to the P2P system a record, whose content is at least partly encrypted with the first transacting party's private key, indicating that it is transferring a specified value of digital currency to some other party transacting on the P2P system. The transaction record sent by the first transacting party can then be added to one or more ledgers maintained at one or more the devices constituting the digital currency P2P system 108. In the example of FIG. 1, copies of a transaction ledger 140 are illustrated as being maintained at the devices 110a, 110e, and 110f, but the transaction ledger may be maintained at any of the other devices constituting the P2P system 108. In some embodiments, some of the devices of the P2P system 108 may maintain a digest of the ledger 140, while some other devices may be configured to contact a trusted device(s) that maintains a copy of the ledger to request specific information from it when needed. In some embodiments, the devices associates with the parties to the transaction may also be part of the transaction ledger implementation. For example, either one of the devices 110d and/or 110j (which are associated with the properties 120 and 130, respectively) may be used to maintain at least part of the transaction ledger.

The authenticity of the transaction record can subsequently be verified by other parties/devices connected to the P2P system based on the public key of the first transacting party. In some embodiments, public keys of transacting parties are maintained with the ledgers (e.g., maintained at the devices that are used to maintain the ledger of transactions), and those public keys can be used to authenticate transaction records. In some embodiments, a participant party on the P2P system may buy credit/digital currency (i.e., credit that can be used in subsequent transactions), and have a public key generated that becomes associated with the newly acquired credit. A record that includes the party's newly acquired credit and the public key associated with that credit can then be added to the ledger of the P2P system. In some embodiments, a transaction record signed with a party's private key may include the public key corresponding to the private key, to thus enable verification of the signed transaction record.

The P2P system 108 generally also includes a verification mechanism, implemented at one or more of the devices 110a-k constituting the P2P system 108, to verify/confirm that posted transactions records are authentic and can be relied upon (as reflecting bona fide transactions between transacting parties, and as reflecting trusted records of digital currency transfer). In some embodiments, the verification mechanism may be implemented through a process called mining in which individual devices in the P2P system perform processing operations on newly added transaction records (different devices may retrieve recently relied records from ledgers maintained at various devices of the P2P system). Thus, in some embodiments, the verification process may include: a) broadcasting new transactions to some or all nodes/devices of the P2P system 108, b) determining a proof-of-work solution to a block of recently collected transaction records, c) when a node finds a proof-of-work solution, the node then broadcasts the solution (with the recent transaction records) to some or all other nodes/devices of the P2P system. Other nodes accept the broadcast solution and transaction block sent by the particular node/device if all the transactions in the broadcast block are valid (e.g., the posted transactions can be confirmed using public keys for the devices/parties that posted the transaction records) and another valid solution was not already broadcast by some other node/device.

The processing performed on new transactions records may include performing a computational task on a block of transactional records collected over some predetermined period of time (e.g., 10 minutes). For example, in some embodiments, the computational task includes finding a solution (e.g., a value N, referred to as a Nonce) such that the application of a hashcode function (e.g., SHA-256, a scrypt procedure, etc.) to data that includes the block of recent transaction records, L, and the value of N being sought, produces a value meeting some agreed upon constraint, e.g., the generated hashcode is less than a threshold value T, i.e., SHA(L+N)<T, where T is some previously agreed upon value that may be periodically changed (that value can also be specified as a pre-determined number of ‘0’s in the hashcode). Because hashcost functions are one-way functions, determination of the solution to the particular computational task being performed requires finding, through an iterative trial-and-error process, an appropriate value of N such that when the hashcost function is applied to the combined data of L and N (e.g., L+N) yields a hashcode (denoted H) meeting the particular constraint. Individual devices in the P2P system 108 may thus independently attempt to find a solution to the particular computation task, and once such a solution is determined, the device that determined the solution broadcasts/ publishes data that includes the transactional records and the determined solution (e.g., a record comprising of the H and N values) to some or all devices in the P2P system 108. Because multiple devices may independently attempt to find a solution to the computation task involving the current block of transaction records, the first solution block to be broadcast becomes the consensus solution block that is accepted by all other devices/nodes of the P2P system 108. Subsequent transaction records are then added to a new block that is appended to the ledger chain (the ledger chain being a concatenation of all previously posted solution blocks). In some embodiments, updated transaction ledgers (that include the just completed ledger block and the solution for the most recent transaction block) will include a chain of all previously verified blocks (e.g., where each block includes a collection of transaction records completed in a particular time period, a nonce value N that was determined/computed for that block, and the previous hashcode value computed for the preceding ledger chain block). In some embodiments, when creating a block to be verified, a mining party/device (“miner”) can add two transactions to the block. One of the added transactions may be a transaction to allocate a reward agreed by the P2P system to an address of the miner's choice (the block reward). This reward may be fixed, or it may decrease or increase over set time periods (e.g. halve every four years), or be proportional or inversely proportional to the difficulty set by the network. The other added transaction may be used to allocate any difference between the inputs of each transaction in the block and the outputs of that transaction to the address of the miner's choice (the transaction fees). For example, in a system implementing Bitcoin, a transaction may indicate that “I am spending X credits [i.e., the input to the transaction], and I am allocating X-d credits to address A.” X-d may be less than or equal to X, and may represent a kind of “spare change” that the miner can allocate to its own address as a form of reward for performing the mining. Further details regarding implementations of a peer-to-peer digital currency system, such as bitcoin, altcoin, etc., are provided in the reference “Bitcoin: A Peer-to-Peer Electronic Cash System” by S. Nakamoto, the content of which is incorporated herein by reference in its entirety.

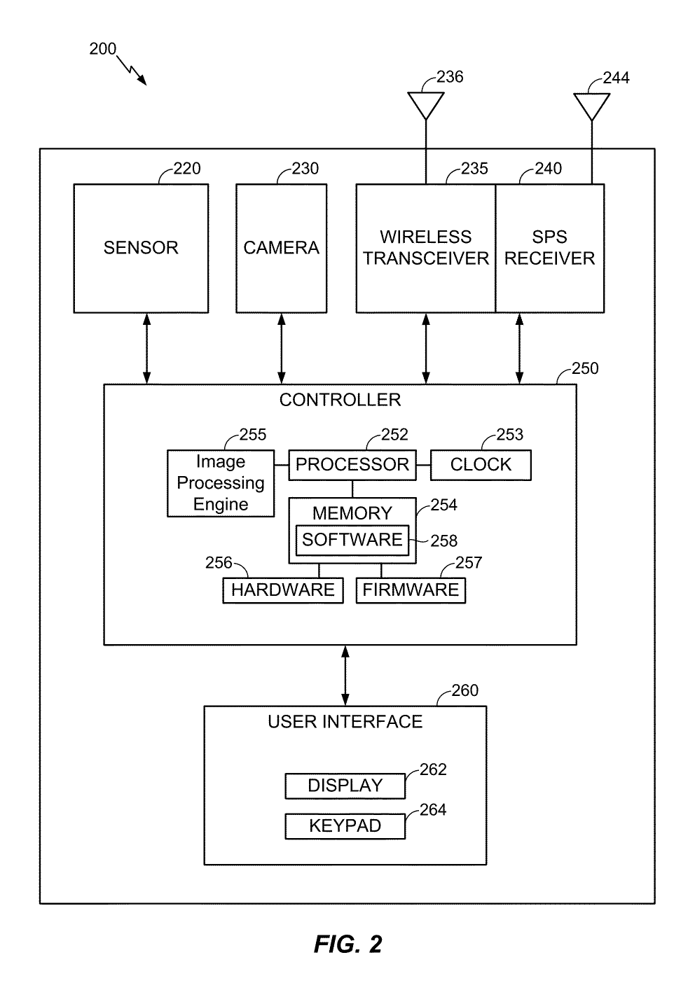

With reference now to FIG. 2, a block diagram of a communication device 200, which may be similar, at least in part, to any one of the devices 110a-k depicted in FIG. 1, is shown. As noted, in some embodiments, one or more of the devices 110a-k may be a mobile device, or may be a stationary communication device (e.g., a stationary device integrated into a property to control access to the property via the integrated communication device). In some embodiments, access points, such as the access points 104 and/or 106a-b shown in FIG. 1, may be implemented, at least in a part, in a manner similar to the device 200 of FIG. 1, and may be part of the implemented P2P system. As illustrated in FIG. 2, in some embodiments, the communication device 200 may include at least one sensor (e.g., an orientation/inertial sensor) 220, which may be, e.g., a magnetometer, an accelerometer (e.g., a 3D accelerometer), a gyroscopes, etc. Although only one sensor is depicted, additional sensors may be included with the device 200. The communication device may further include an image capturing device, such as a camera 230 (e.g., a charge-coupled device (CCD)-type camera, CMOS-type camera, etc.), which may produce still or moving images (e.g., a video sequence) that may be displayed on a user interface device, such as a display or a screen.

The communication device 200 may include a receiver 240, such as a satellite positioning system (SPS) receiver that receives signals from a SPS satellites (such as the satellite 102 of FIG. 1) via an antenna 244. The communication device 200 may also include at least one wireless transceiver 235, which may be, e.g., a cellular modem or a wireless network radio receiver/transmitter configured to send and receive communications to and from one or more wireless access points (such as any of LAN-WAP 106a-b and/or the WAN-WAP 104), to send and receive messages/communications with peer devices in a P2P system (including communications directed to a transaction for using a property of an owner associated with one of the devices of FIG. 1), and/or to send to, and receive messages/communications from, any other type of network node configured for wireless/cellular communication. Communication to and from the wireless transceiver may be enabled via a dedicated antenna 236, via the antenna 244, or via some other antenna. In some implementations, the communication device 200 may include separate transceivers that serve as the cellular modem and the wireless network radio receivers/transmitters, and may include multiple dedicated transceivers that may communicate in dedicated communication modes/protocols.

The SPS receiver 240 and the at least one wireless transceiver 235 (as well as other units/modules of the device 200, such as the at least one sensor 220, the camera 230, etc.) are connected to, and communicate with, a controller 250. The controller 250 is configured, for example, to send a transaction request to use a particular property, to communicate with various devices of a P2P system, to perform tasks associated with the maintenance of the P2P system 108 (e.g., to maintain a copy of the transaction ledger, perform mining/verification processes with respect to unprocessed blocks of transactions and/or with respect to posted ledger blocks comprising processed transactions and proof-of-work solutions, etc.), to control access to a property(ies) associated with the device 200, to control operation of the various on-board units/modules of the device 200, to control general operation of the communication device 200, etc. For example, in some embodiments, the controller 250 is configured to send a request to obtain use rights for a property (e.g., a house, a room, a car, etc.) belonging to a second party associated with a second network device (which may also be similar to the device 200) in a P2P system/network. The controller 250 may be configured to include in the request message being sent data representative of a required number of commercial-valued credits to transfer to the second party associated with the property, and to further include data representative of a requested starting time and time duration at which use of the property by the first party associated with the first network device is to occur. In some embodiments, the controller 250 may cause processing of the request message with a private key associated with the communication device 200. The controller 250 is further configured to cause, subsequent to sending of the request, communication with the second network device associated with the property in order to access, by the first party, the property. Additionally and/or alternatively, in some embodiments, the controller 250 may also be configured to perform operations to control and enable access to an associated property, including such operations as exchanging one or more communications with another network device associated with another party, and determining at the second network device, based on the one or more communications sent from the other network device and based on a request previously sent by the other network device to a peer-to-peer system, whether to provide the other party associated with the other network device access to the property. When the controller 250 is configured to control and enable access to a property, the controller may be configured to send to a lock (e.g., an electrically actuated lock or barrier, such as the lock 122 of FIG. 1), installed on the property associated with the device, a signal to unlock the lock that is restricting access to the property.

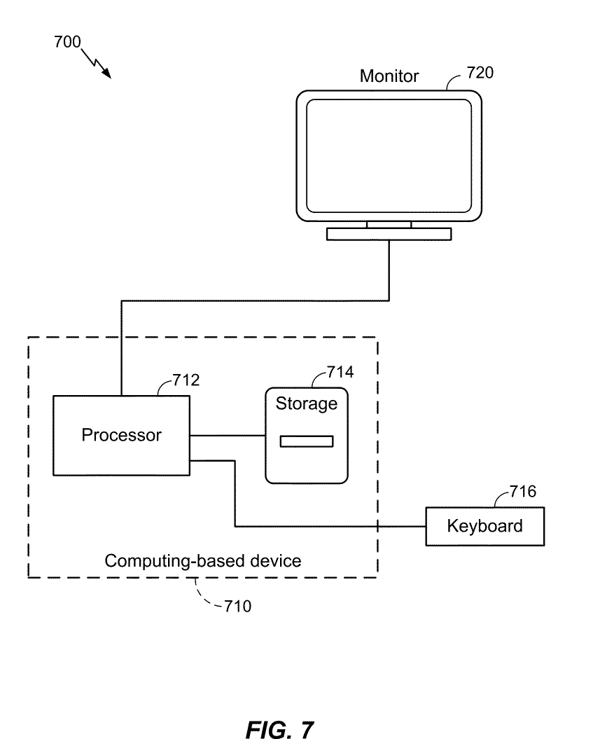

The controller 250 may include, in some implementations, a processor 252 and associated memory 254, a clock 253, hardware 256, software 258, and firmware 257. The mobile station controller 250 may further include, in some embodiments, a dedicated image processing engine 255, which is illustrated separately from the processor 252 for clarity, but which may constitute part of the processor 252. The processor 252 may, but need not necessarily include, one or more microprocessors, embedded processors, controllers, application specific integrated circuits (ASICs), digital signal processors (DSPs), and the like. As used herein the term “memory” refers to any type of non-transitory computer storage medium, including long term, short term, or other memory associated with the communication device, and is not to be limited to any particular type of memory or number of memories, or type of media upon which memory is stored. Further details regarding an example embodiment of a processor or computation system, which may be similar to the processor 252, are provided below in relation to FIG. 7.

The communication device 200 may also include a user interface 260 that is in communication with the controller 250, e.g., the controller 250 may accept data from, and control, the user interface 260. The user interface 260 includes a display 262 that may display images, including images produced by the camera 230. The display 262 may further display control menus, positional information, content, etc. The user interface 260 further includes input interface devices, such as, for example, a keypad 264, a touch screen (not shown), a microphone and speaker (not shown), or other input device through which the user can provide input to the communication device 200.

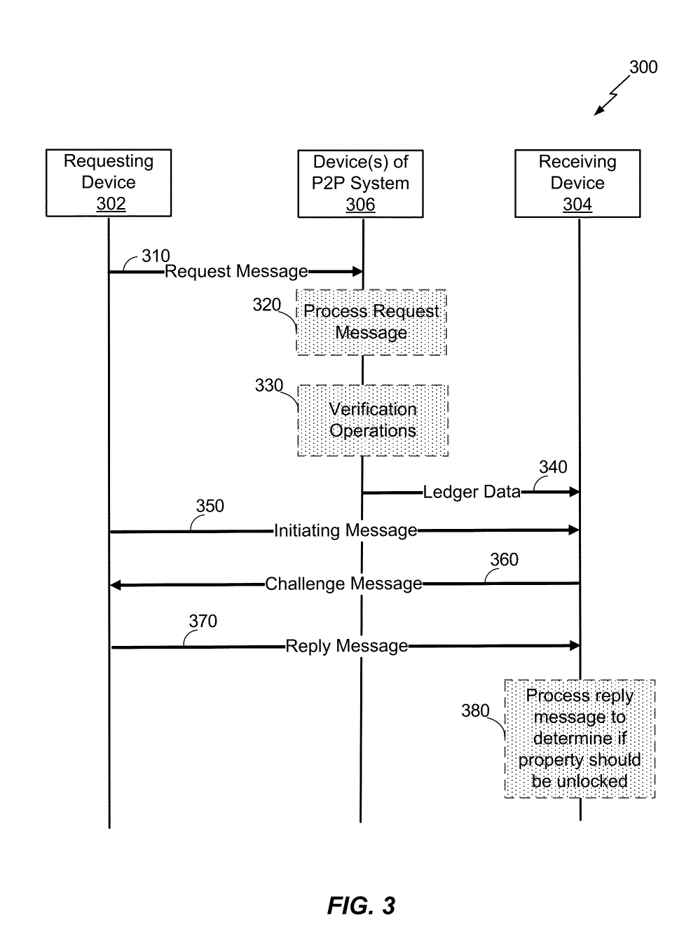

As noted, the devices 110a-k constituting the P2P system 108 are configured to facilitate implementation of transactions between any two individual devices without requiring a central server or central device to facilitate or oversee the transaction. Thus, a transaction involving transfer of a form of payment between two devices may be consummated without requiring a central system to guarantee the propriety and/or integrity of the transaction. FIG. 3 is a signal diagram 300 showing example operations and messages/communications exchanged in performing an example transaction process between two individual devices of a P2P network/system, e.g., a transaction between a requesting device 302 (which may correspond to, in this example, to the device 110g of FIG. 1) and a receiving device 304 (which may correspond to the device 110d of the P2P system 108 depicted in FIG. 1) to acquire use rights for a property (e.g., a hotel room, such as the hotel room 120 of FIG. 1) associated with receiving device. In some embodiments, the requesting device 302 may itself be associated with a particular property (which may be different from the property associated with the receiving device 304), and may thus be configured to respond to transaction requests sent to the P2P system for use of that particular property by interacting with other requesting devices to provide access to the property associated with the requesting device 302. Similarly, the receiving device 304 of this example may be configured to send request messages, and to interact with other devices of the P2P system in order to obtain use and/or access to properties associated with such other devices.

In the present example, the requesting device 302 (or the device 110g) seeks to acquire use rights from the party that owns the property 120 and is associated with the receiving device 304 (or the device 110d). Initially, upon determining a possible date, time and duration with respect to which the party associated with the requesting device 302 wishes to use the property, e.g., based on schedule/reservation data for the property that may be stored at one or more of the devices of the P2P network/system, and which may be obtained (e.g., downloaded) to the requesting device 302, the requesting device 302 sends a request message 310 to P2P system 306 (which may be similar in configuration and functionality to the P2P system 108 of FIG. 1). For example, the request message 310 (i.e., a transaction record) may be broadcast to multiple devices of the P2P system 306, or may be transmitted to selected devices of the system 306, whereupon the devices receiving the request (transaction record) may, in some embodiments, transmit the received request message 310 to additional devices of the P2P system 306. In some embodiments, the request message may be transmitted to one or more of the devices of the system 306 on which a transaction ledger, such as the ledger 140 depicted in FIG. 1, is maintained (the request message 310 may be communicated to the devices maintaining the ledger either directly by the requesting device 302, or indirectly via intermediate nodes en route to the device(s) maintaining the transaction ledger for the P2P system). As noted, in some embodiments, the requesting device 302 may itself also maintain a copy of the transaction ledger for the particular P2P system using a particular digital currency implementation, and thus, in such embodiments, sending the request message 310 would include providing the request message to the locally maintained transaction ledger.

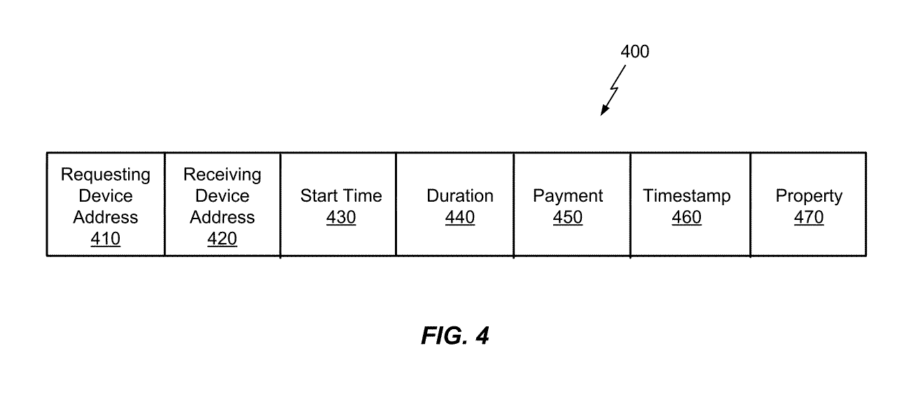

FIG. 4 is a schematic diagram of an example request message 400, which may be similar to the request message 310 of FIG. 3. As shown, the request message 400 includes a requesting device address field 410 that includes data representative of a network address, e.g., an IP address associated with the device sending the request, a network address identifying the address of the device in the P2P system through which the transaction initiated via the request message 410 is to be performed, and/or any other address associated with the requesting device/party. The requesting message also includes a second, receiving device, network address field 420 specifying the network address of the receiving device such as the devices 110d or 304 (associated with the property that the party associated with the requesting device is seeking to use), which, like the field 410, may also include an IP address, a specific P2P address associated with the receiving device, and/or any other type of a network address associated with the second network device that may also be used to identify the receiving party. In some embodiments, an optional field 470 may also be included with the message 400 to identify the property (e.g., property address, property identification number, property description, etc.)

As further illustrated in FIG. 4, the request message 400 also includes a start time field 430 specifying the date and time at which the party associated with the requesting device wishes to start using the property associated with the second device, and further includes a duration field 440 specifying the duration (hours, days, etc.) for using the property. The start time and duration may need to be verified to ensure that the property in question is available during the period define by the start time and duration specified in the fields 430 and 440. The request message 400 also includes a payment field 450 specifying the amount of the digital currency (i.e., the digital currency established by the particular P2P system implementation) that is to be transferred from the party associated with the first, requesting, device to the party associated with the second, receiving, device (e.g., transferred to a party associated with the network address specified in the field 420 of the message 400). The amount of the digital currency required for completion of the transaction may be provided via the scheduling/availability information based on which the requesting device generates and communicates the request message 400. For example, scheduling information for the hotel room 120 or the car 130 depicted in FIG. 1 may also indicate the price (in digital currency) per unit of time (e.g., per hour, per day, etc.) to use the property in question. The payment field 450 would thus indicate an amount corresponding to the product of the duration requested by the first user (represented in the units or duration at which the use price for the property is provided) and the price per unit (e.g., N days×P/day, where P is the price per day, and N is the requested duration in days). In some embodiments, the message 400 may also include a timestamp field 460 indicating the time at which the request was made/generated. The message 400 may include additional or fewer fields than those depicted in FIG. 4.

The requesting device may be configured to process (e.g., sign/encrypt) at least a portion of the data included in the request message using its private key (from the asymmetric private/public cryptographic key, such as an ECDSA key, assigned to the requesting device) to confirm that authenticity of the sent request. Thus, a processing device, e.g., one of the devices of the P2P system on which a copy of the transaction ledger is maintained, can use the public key of the requesting device (that public key may already be available at the processing device, or may have been included with the request message) to decrypt the request message, and to independently confirm the details in the message, including to determine whether the first party has sufficient balance of digital currency to cover the amount of digital currency requested in the request message to be transferred to the second party.

With continued reference to FIG. 3, the request message 310 is thus sent to one or more of the devices of the P2P system (e.g., one or of the devices 110a-k of the P2P system 108 of FIG. 1) that facilitate maintaining a transaction ledger (such as the transaction ledger 140 of FIG. 1). In the example of FIG. 1, the request message from the requesting device 110g may be communicated to the devices 110a, 110e, and 110f on which the transaction ledger for the P2P system 108 is maintained (these devices are referred to herein as ledger devices). At the ledger devices of the P2P system, the request message 310 is, in some embodiments, processed 320 (e.g., decrypted) using the public key associated with the requesting device. For example, data identifying the requesting device, e.g., an address or identification of the device in a metadata of the message, or the address data in the example field 410 of the message 400 in embodiments in which at least the requesting device address field 410 is not encrypted, is used to obtain the public key associated with the requesting device 302. In some embodiments, the public key may be maintained at the ledger devices (the public key may have been added to the ledger at an earlier time, e.g., upon receipt of an earlier transaction record involving the party associated with the requesting device 302), or may be provided to the ledger device with the request message 310 (i.e., with the transaction record). In some embodiments, the ledger device(s) may make a request to a one or more trusted device(s) maintaining a repository of public keys for the various devices of the P2P system to transmit to the ledger device(s) the public key for the particular device that sent the message 410. Once the request message 310 is processed to recover the data included therein, the ledger device(s) add the request message to the current batch of unprocessed transaction requests if the decrypted request message is already formatted so that it can be processed with other such unprocessed requests, or, alternatively, the ledger device(s) may generate a transaction record(s) populated with data that is based on the data in the request message 310. Such a transaction record(s) may, for example, identify the parties to a transaction to be processed (specified as, for example, the network addresses, or some other type of identification), the amount of digital currencies to be transferred between the parties, commission to be transferred to devices/parties facilitating the transaction (e.g., to device(s) that perform digital currency mining operations), and may also include other information germane to the processing of the transaction(s) in question. In some embodiments, the information in the request message 310 that pertains to the date, time, and duration at which the first party wishes to use the property of the second party may be used to generate another record that is then forwarded to the receiving second device (associated with the second party) to notify it of a possible reservation that is being scheduled/transacted.

As transaction records are being collected, one or more mining devices of the P2P system 108 or 306 (such devices may include, in some embodiments, the ledger devices at which the transaction records have been collected and/or any other device of the P2P system) obtain unverified records, at pre-defined intervals (e.g., 10 minute intervals) that can be dynamically adjusted, and perform verification operations 330 on the unverified records in a process referred to as mining. For the purpose of illustration, assume that the devices 110b and 110i of the P2P system 108 of FIG. 1 both obtain the unverified records (possibly from different ledger devices), and each of the verifying devices 110b and 110i performs the mining/verification processing described herein. Particularly, as noted, in some embodiments, the verification process includes performing a proof-of-work task in which a value, N, is to be determined such that when combined with the data from the non-processed/non-verified transaction records, and a hash function is applied, the resultant hashcode satisfies a particular constraint (e.g., the resultant hashcode needs to have a pre-determined number of leading ‘0’ bits). In some embodiments, the proof-of-work criterion may be adjusted dynamically so that if solutions to blocks are being determined too quickly, the difficulty can be increased (e.g., more ‘0’s can be required at the beginning of the next block). The difficulty level for the proof-of-work criterion may be set by a public formula, e.g., a formula setting the difficulty level to be, for example, inversely proportional to the average time it took to find the last N blocks, times some constant K, where K is selected to give the desired or targeted pre-defined interval (for example, 10 minutes). In some embodiments, if, during the verification process, more transactions appear on the P2P system/network, those transactions may be appended to the block being processed so that the solution sought is determined for the modified block (i.e., with the added transactions).

In some embodiments, the first of the verification devices to determine a solution to the proof-of-work task broadcasts the processed transaction data (with the determined solution) to the P2P system, and that processed data become the consensus ledger data for the entire P2P system. In some embodiments, the broadcast data includes the transaction records, the currently identified value of N, and a haschode corresponding to the previously processed block of transaction data and the previous N value determined for that previous block of transaction data. The broadcast data, corresponding to the now updated transaction ledger, may be received and maintained at one or more of the devices of the P2P system, including, for example, at the same ledger devices that previously maintained the ledger data and to which unprocessed request messages and/or transaction records were communicated.

In some embodiments, the verification devices (i.e., the “miners”) may be configured to implement double-booking-prevention functionality. Thus, when a mining/verification device determines or identifies two separate transactions to book a particular property (a good or service) at the same or overlapping time (in situations where a property can only be used by one party at a time), the first party whose booking transaction is included in the P2P public ledger will get the rights to the property. In such implementations, the “miners” will be configured to refuse to include a subsequent transaction to acquire use right for a property during a time that has already been reserved by another party in a current or previous block.

Periodically, the receiving device 304, associated with the property being made available for use (e.g., the property 120, associated with the device 110d, in the present example), is configured to obtain 340 ledger data that may include the now processed transaction record corresponding to the request message 310 sent by the device 110g. The network device 110d may be configured to search the transaction ledger to identify records identifying the device 110d (or the party associated therewith) as a recipient/transferee of digital currency from another transacting party. Searching the ledger records may be performed only for records covering the period since the last time that the receiving device (e.g., the device 304 or 110d) obtained and searched the transaction ledger of the P2P system. Alternatively, the receiving device 110d may request a remote device maintaining an updated transaction ledger to search the ledger's records for records that identify the party associated with the device 304 (thus avoiding the need to periodically download large volumes of data constituting the transaction ledger). As noted, in some embodiments, reservation details (e.g., particulars pertaining to the date, time, and duration that another party is requesting to use the property in question) may have been previously communicated to the receiving device 304.

At some subsequent time instance (e.g., after the request message 310 has been sent by the requesting device 302 and processed by the devices of the P2P system 306, and an updated transaction ledger was obtained by the receiving device 304), the party associated with the requesting device may wish to access and start using the property it reserved via the request message 310. In some embodiments, the party associated with the requesting device may be able to cancel the transaction up until the start time specified in the original request (e.g., sent in the request message 310). Cancelling the transaction may be performed, for example, by sending a cancellation request, which may be similar to the request message 310, to cancel or reverse the transaction represented by the request message 310.

As illustrated in FIG. 3, when the requesting party wishes to use the property it reserved, the requesting network device is configured to communicate, subsequent to the sending of the request message 310, with the second, receiving, network device 304 associated with the property to be used, in order to enable access by the requesting party of the property to be used. As noted, in some embodiments, the receiving network device 304 may be part of a lock or barrier system or barrier that can be electrically unlocked or released in response to a message exchange between the requesting and receiving network devices, based on which it can be determined that the requesting device is indeed the device associated with the party that requested use of the property at a date and time matching the present date and time, and that the first party has in fact transferred (paid) the digital currency price required to use the property. Thus, in some embodiments, the communication between the requesting network device and the receiving (second) device includes establishing a communication link between the requesting and receiving devices, e.g., by sending an initiating message 350 from the requesting device 302 to the receiving device 304. The initiating message 350 may include data representative of the identity or address (e.g., network address) of the device or party associated with the device, and other information associated with the transaction or the property (e.g., a confirmation number that may have been provided by some scheduling/reservation application executing on one of the devices of the P2P system, details of the reservation, etc.) The communication link may be established based on any communication protocol and/or technology supported by the requesting and the receiving devices. For example, if subsequent to reserving the property (e.g., by sending the request message 310) the party associated with the requesting device 302 or 110g travels to the location where the property 120 is located, the requesting device may attempt to establish a near-field communication link (e.g., Bluetooth® wireless technology or Zigbit) with the receiving device associated with the property. Alternatively, the two devices may establish a communication link based on WLAN protocol, a WWAN protocol etc., with such a communication link being a direct link between the two devices, or an indirect link passing via intermediary access points (e.g., through the WLAN access points 106a-b in the example of FIG. 1, through the example WWAN base station 104, etc.) When establishing a communication link based on a non-near-field communication protocol, the requesting device may be located near the property (e.g., if the party associated with the requesting device wishes to gain immediate entry into the property) or may be located farther away (e.g., if it is attempting to gain entry on behalf of another person).

Once the communication link has been established, the receiving network device 304 associated with the property (which, as noted, may be incorporated/integrated into a lock system for the property) generates and sends to the requesting device 302 a challenge message 360 that includes a challenge (e.g., a nonce generated by the receiving device 304). In some embodiments, to improve security (e.g., to ensure that the challenge message was indeed sent by the receiving network device that is associated with the property in question), the challenge included in the challenge message 360 may be encrypted with a private key associated with the receiving device 304 so that the requesting device 302 can determine that the challenge was indeed submitted by the receiving device 304 (in effect, the receiving device is “signing” the challenge to prove it is a valid challenge). The requesting device 302 receives the challenge message sent by the receiving device 304 and processes the challenge (using, if needed, the public key for the receiving device 304). For example, in some embodiments, the requesting device 302 may read the nonce sent in the challenge message 360 (if needed, by decrypting the nonce when the challenge was encrypted with the receiving device's private key), encrypt the nonce using its own private key (i.e., the private key for the requesting device 302), and include the encrypted nonce in a reply message 370 to be sent back to the receiving device 304.

The receiving device 304 can subsequently decrypt the encrypted nonce (or other challenge) using a public key associated with the device/party that is presumed to be the transacting requesting party (i.e., the party that actually seeks to use the property and has transferred digital currency payment for the right to use the property) to thus confirm the identity of the device/party with which it is communicating as the party entitled to access the property. In some embodiments, the receiving device may obtain the public key for the requesting device from a trusted device, e.g., a ledger device (i.e., a device maintaining the transaction ledger) that maintains the public keys for the various devices of the P2P system/network. Thus, upon receiving the message 370 from the requesting device 302, the receiving device 304 processes 380 the message 370, including reading the content of the reply message 370, and decrypting the encrypted nonce message included in the reply message 370 using a public key associated with the network device or party identified in transaction information (e.g., obtained from ledger records or from other communications previously received by the receiving device 304 regarding identity the transaction and the transacting party that is supposed to be accessing the property). In response to a determination (e.g., also at 380) that the decrypted challenge (decrypted nonce) matches the challenge/nonce sent by the receiving device 304 with the challenge message 360, that the correct digital currency amount was transferred to the party associated with the receiving device 302 (as can be determined based, for example, on ledger record(s), corresponding to the present transaction, obtained by the receiving device 304 from other devices on the P2P system), and also, optionally, that the present time matches the period defined by the start date/time and duration specified in the request message 310, the receiving device 304 is configured to cause the lock system or barrier (e.g., which may be similar to the lock 122 of the property 120 depicted in FIG. 1) to unlock or be released, thus enabling the party associated with the requesting device (or some other person on whose behalf the requesting device is communicating with the receiving device) to access the property. In some embodiments, the property accessed may include one or more of, for example, a hotel room with a lock controlled by the receiving network device, a vehicle that can be locked/unlocked and otherwise controlled by the receiving network device, a parking meter, and/or any other time-accessible good or service. Digital currency earned by the party associated with the receiving device 304 may be used or redeemed in order to, for example, enter into transactions with other devices/parties of the P2P system 306.

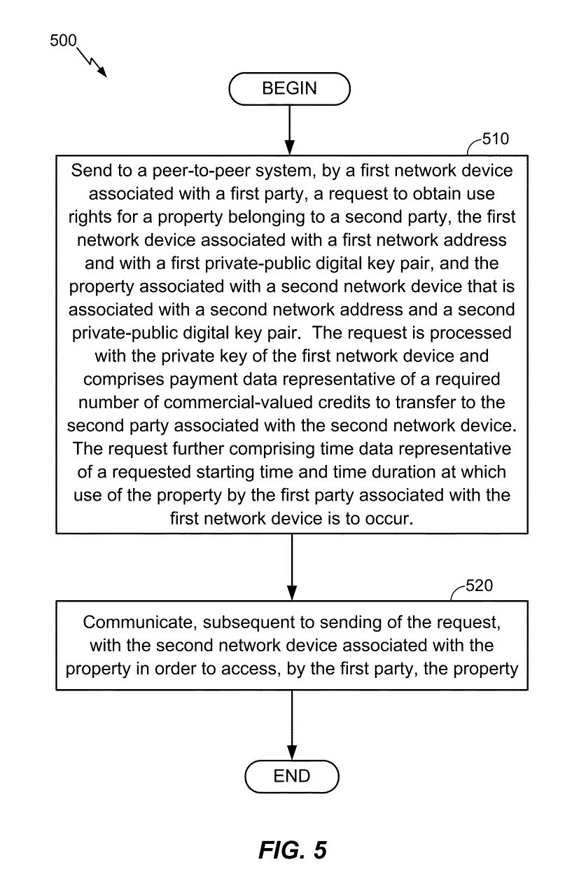

With reference to FIG. 5, a flowchart of an example procedure 500, generally performed at a first network device to acquire use rights of a property associated with another, second, network device, is shown. The procedure 500 includes sending to a peer-to-peer system (such as the P2P system/network 108 depicted in FIG. 1, or the P2P system/network 306 schematically shown in FIG. 3), by a first network device (such as the device 302 of FIG. 3) associated with a first party, a request to obtain use rights for a property belonging to a second party. As noted, the first network device is associated with a first network address (e.g., a general IP address assigned to the requesting device, a P2P address corresponding to the P2P system implementation, etc.) and with a first private-public digital key pair (e.g., an asymmetric key pair). The property that the party associated with the first network device seeks to access and use generally includes a second network device (such as the device 304 of FIG. 3, or the device 110d of FIG. 1) that may be a stationary device coupled to, or integrated with, a lock system controlling access to the property. Alternatively, the second network device may be a mobile device configured to establish a communication link with a communication module integrated into the lock system of the property, and to send control signals to the lock system to control access into the property. The second network device is associated with a second network address, which may also include an assigned IP address, a P2P-specific address or identification, etc., and is further associated with a second private-public digital key pair (e.g., an asymmetric key pair). The request communicated (e.g., as a message which may be similar to the request message illustrated in FIGS. 3 and 4) is processed (e.g., encrypted) with the private key of the first network device and includes, for example, payment data representative of a required number of digital currency amount (e.g., commercial-valued credits) to transfer to the second party associated with the second network address associated with the second network device of the property. The request further includes time data representative of a requested starting time and duration at which use of the property by the first party associated with the first network device is to occur.

As further illustrated in FIG. 5, the procedure 500 also includes communicating 520, subsequent to sending the request, with the second network device associated with the property in order to access (by the first party) the property. In some embodiments, and as described herein in relation to FIG. 3, communicating with the second network device may include establishing a communication link (e.g., near-field link, a WLAN link, a WWAN link, etc.) with the second network device. The communication link may be established by sending an initiating message (e.g., such as the message 350 of FIG. 3) from the first network device to the second, receiving, network device. Once the communication link is established, a challenge message (e.g., such as the message 360 of FIG. 3) including a challenge (e.g., a nonce) transmitted form the second network device is received by the first, requesting, network device. The first network device generates a reply message (e.g., the reply message 370 of FIG. 3) that is processed by the first network device's private key. For example, the first network device may encrypt using its private key the nonce it received, and add the encrypted nonce data into the reply message. Subsequently, in response to a determination (e.g., generally performed at the second network device) that the required number of commercial-valued credits was transferred to the second party, that the reply message decrypted with the public key of the first network device includes a proper response to the challenge (e.g., the nonce sent to the first network device matches the decrypted nonce data in the reply message that was encrypted with the first network device's private key), and, optionally, that the present time matches the period defined in the request, the property belonging to the second party may be accessed by the first party (or a party affiliated or associated with the first party). Access to the property may be achieved by the second network device sending control signals to cause an electrically-actuated lock, or barrier, coupled to the second network device, or in communication with the second device, to unlock and allow access to the property. Thus, as described herein, parties in a P2P system implementing a digital currency framework may transact for use-based transaction (e.g., rental transaction) without requiring a central credit or banking agent, through communication that can be completed with the parties' respective network devices (e.g., mobile devices).

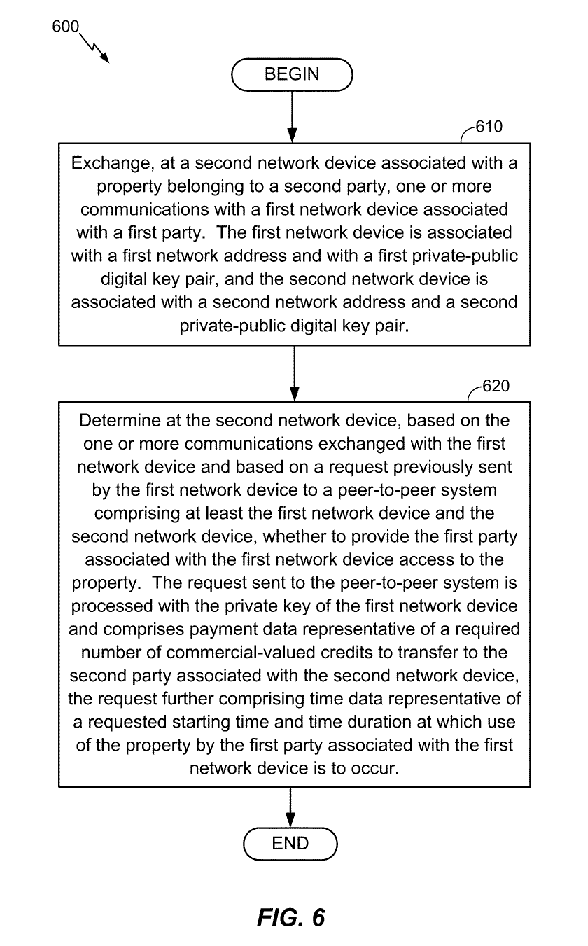

With reference now to FIG. 6, a flowchart of an example procedure 600, generally performed at a second, receiving, network device, to enable two parties to transact for acquisition of use rights of a property owned by the party associated with the second, receiving device, is shown. The procedure 600 includes exchanging 610, at the second network device (associated with a second private/public key pair and with a second network address, which, as described herein, may be an IP address, a P2P system/network address, or any other type of address or identification to identify and communicate with the second network device) one or more communications sent by a first network device (associated with a first network address and with a first private-public digital key pair) associated with a first party. In some embodiments, exchanging the one or more communications may include receiving (at the second network device) an initiating communication to establish a communication link (e.g., a near-field communication link, and/or a link based on any other type of communication protocol, including a WWAN link, a WLAN link, etc.) with the first network device, transmitting to the first network device, by the second network device, a message comprising a challenge (e.g., a nonce challenge), and receiving at the second network device a reply message, transmitted form the first network device, responsive to the challenge, the reply message processed with the private key of the first network device.

Based on the one or more communications sent from the first network device and based on a request previously sent by the first network device to a peer-to-peer system comprising at least the first network device and the second network device, a determination is made 620 whether to provide the first party associated with the first network device access to the property. The request sent to the peer-to-peer system is processed with the private key of the first network device and includes payment data representative of a required number of commercial-valued credits (Bitcoin credits/tokens, altcoin credits/tokens, or any other type of digital currency) to transfer to the second party associated with the second network device, and further includes time data representative of a requested starting time and time duration at which use of the property by the first party associated with the first network device is to occur. In some embodiments, determining whether to provide the first party access to the property may include providing the first party with access to the property in response to a determination that the required number of commercial-valued credits was transferred to the second party associated with second network device, that the reply message decrypted with the public key of the first network device, obtained by the second network device, includes a proper response to the challenge, and, optionally, that the present time matches a period defined by the start date/time and duration specified in the request.

Performing the procedures described herein may be facilitated by a processor-based computing system. With reference to FIG. 7, a schematic diagram of an example computing system 700 is shown. The computing system 700 may be housed in, for example, a communication device such as the devices any of the device 110a-k and 200 of FIGS. 1 and 2, respectively, and may comprise part or all of the access points 104 and 106a-b depicted in FIG. 1. The computing system 700 includes a computing-based device 710 such as a personal computer, a specialized computing device, a controller, and so forth, that typically includes a central processor unit 712. In addition to the CPU 712, the system includes main memory, cache memory and bus interface circuits (not shown). The computing-based device 710 may include a mass storage device 714, such as a hard drive and/or a flash drive associated with the computer system. The computing system 700 may further include a keyboard, or keypad, 716, and a monitor 720, e.g., a CRT (cathode ray tube) or LCD (liquid crystal display) monitor, that may be placed where a user can access them (e.g., a mobile device's screen).

The computing-based device 710 is configured to facilitate, for example, the implementation of the procedures described herein. The mass storage device 714 may thus include a computer program product that when executed on the computing-based device 710 causes the computing-based device to perform operations to facilitate the implementation of the procedures and operations described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), a DSP processor, or an ASIC (application-specific integrated circuit) may be used in the implementation of the computing system 700. Other modules that may be included with the computing-based device 710 are speakers, a sound card, a pointing device, e.g., a mouse or a trackball, by which the user can provide input to the computing system 700. The computing-based device 710 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as machine-readable signals.

Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising:
sending to a peer-to-peer system, by a first network device associated with a first party, a request to obtain use rights for a property belonging to a second party, the first network device associated with a first network address and with a first private-public digital key pair, and the property associated with a second network device that is associated with a second network address and a second private-public digital key pair, wherein the request is processed with the private key of the first network device and comprises payment data representative of a required number of commercial-valued credits to transfer to the second party associated with the second network device, the request further comprising time data representative of a requested starting time and time duration at which use of the property by the first party associated with the first network device is to occur; and
communicating, subsequent to sending of the request, with the second network device associated with the property in order to access, by the first party, the property.

2. The method of claim 1, wherein communicating with the second network device associated with the property comprises:
establishing a communication link with the second network device;
receiving, by the first network device, a message comprising a challenge transmitted form the second network device associated with the property;
sending to the second network device a reply message responsive to the challenge, the reply message processed with the private key of the first network device; and
in response to a determination that the required number of commercial-valued credits was transferred to the second party associated with the second network device and that the reply message decrypted with the public key of the first network device includes a proper response to the challenge, accessing the property belonging to the second party.

3. The method of claim 2, wherein accessing the property belonging to the second party comprises:
accessing one of: a hotel room, a vehicle, a parking meter, an air-plane seat, a theater, a locker, or another time-accessible good or service.

4. The method of claim 2, wherein the determination that the reply message decrypted with the public key of the first network device includes the proper response to the challenge comprises:
a determination that content of the reply message, encrypted using the private key of the first network device and decrypted at the second network device using the public key of the first network device obtained by the second network device, matches the challenge included in the message sent by the second network device.

5. The method of claim 2, wherein the message sent by the second network device includes a nonce challenge encrypted with the private key of the second network device.

6. The method of claim 2, wherein establishing the communication link with the second network device comprises:
establishing the communication link with the second network device according to a near-field communication protocol when the first network device is within range of the second network device.

7. The method of claim 2, wherein establishing the communication link with the second network device comprises:
establishing the communication link with the second network device according to a non-near-field communication protocol, the non-near-field communication protocol comprising one or more of: a WLAN-based communication protocol, or a WWAN-based communication protocol.

8. The method of claim 1, wherein sending the request to the peer-to-peer system comprises:
communicating the request to one or more network devices of the peer-to-peer system maintaining transaction ledger data for commercial transactions on the peer-to-peer system, the one or more network devices maintaining the transaction ledger data configured to record the transfer of the required number of commercial-valued credits included in the request to the second party associated with the second network device.

9. The method of claim 8, further comprising:
performing verification operations, by one or more additional network devices of the peer-to-peer system, on unprocessed transaction ledger data stored at the one or more network devices maintaining the transaction ledger data, wherein performing the verification operations comprises determining whether the requested starting time and the time duration, indicated in the request sent by the first device, at which use of the property by the first party is to occur is available for use.

10. The method of claim 1, wherein the required number of commercial-valued credits included in the request comprises one or more of: data representative of a required number of Bitcoins, or data representative of a required number of altcoins.

11. The method of claim 1, further comprising:
exchanging one or more communications with a third network device associated with a third party, wherein the third network device is associated with a third network address and a third private-public digital key pair, and wherein the first network device is associated with another property; and
determining at the first network device, based on the one or more communications exchanged with the first network device and based on another request previously sent by the third network device to the peer-to-peer system, whether to provide the third party associated with the third network device access to the other property associated with the first network device, wherein the other request sent to the peer-to-peer system by the third network device is processed with the private key of the third network device and comprises another payment data representative of another required number of commercial-valued credits to transfer to the first party associated with the first network device, the request further comprising another time data representative of another requested starting time and time duration at which use of the other property by the third party associated with the third network device is to occur.

12. A mobile device comprising:
one or more processors; and
storage media comprising computer instructions that, when executed on the one or more processors, cause operations comprising:
sending to a peer-to-peer system, by the mobile device, a request to obtain use rights for a property, the mobile device associated with a first network address, with a first private-public digital key pair, and with a first party, wherein the property belongs to a second party and is associated with a second mobile device associated with a second network address and with a second private-public digital key pair, and wherein the request is processed with the private key of the mobile device and comprises payment data representative of a required number of commercial-valued credits to transfer to the second party associated with the second mobile device, the request further comprising time data representative of a requested starting time and time duration at which use of the property by the first party associated with the mobile device is to occur; and
communicating, subsequent to sending of the request, with the second mobile device associated with the property in order to access, by the first party, the property.

13. The mobile device of claim 12, wherein communicating with the second mobile device associated with the property comprises:
establishing a communication link with the second mobile device;
receiving, by the mobile device, a message comprising a challenge transmitted form the second mobile device associated with the property;
sending to the second mobile device a reply message responsive to the challenge, the reply message processed with the private key of the mobile device; and
in response to a determination that the required number of commercial-valued credits was transferred to the second party associated with the second mobile device and that the reply message decrypted with the public key of the first network device includes a proper response to the challenge, accessing the property belonging to the second party.

14. The mobile device of claim 13, wherein accessing the property belonging to the second party comprises:
accessing one of: a hotel room unlocked in response to the determination that the required number of commercial-valued credits was transferred to the second party associated with the second mobile device, a vehicle unlocked in response to the determination that the required number of commercial-valued credits was transferred to the second party associated with the second mobile device, a parking meter, an air-plane seat, a theater, a locker, or another time-accessible good or service.

15. The mobile device of claim 13, wherein the determination that the reply message decrypted with the public key of the mobile device includes the proper response to the challenge comprises:
a determination that content of the reply message, encrypted using the private key of the mobile device and decrypted at the second mobile device using the public key of the mobile device obtained by the second mobile device, matches the challenge included in the message sent by the second mobile device.

16. The mobile device of claim 13, wherein establishing the communication link with the second network device comprises:
establishing the communication link with the second mobile device according to a near-field communication protocol when the mobile device is within range of the second mobile device.

17. A method comprising:
exchanging, by a second network device associated with a property belonging to a second party, one or more communications with a first network device associated with a first party, wherein the first network device is associated with a first network address and with a first private-public digital key pair, and wherein the second network device is associated with a second network address and a second private-public digital key pair; and
determining at the second network device, based on the one or more communications exchanged with the first network device and based on a request previously sent by the first network device to a peer-to-peer system comprising at least the first network device and the second network device, whether to provide the first party associated with the first network device access to the property, wherein the request sent to the peer-to-peer system is processed with the private key of the first network device and comprises payment data representative of a required number of commercial-valued credits to transfer to the second party associated with the second network device, the request further comprising time data representative of a requested starting time and time duration at which use of the property by the first party associated with the first network device is to occur.

18. The method of claim 17, wherein exchanging the one or more communications with the first network device comprises:
receiving an initiating communication to establish a communication link with the first network device;
transmitting to the first network device, by the second network device, a message comprising a challenge; and
receiving at the second network device a reply message, transmitted form the first network device, responsive to the challenge, the reply message processed with the private key of the first network device.

19. The method of claim 18, wherein determining whether to provide the first party access to the property comprises:
providing the first party with access to the property in response to a determination that the required number of commercial-valued credits was transferred to the second party associated with second network device and that the reply message decrypted with the public key of the first network device includes a proper response to the challenge.

20. The method of claim 19, wherein providing the first party with access to the property comprises:
sending by the second network device a signal to unlock a lock that is restricting access to the property.

21. The method of claim 18, wherein receiving the initiating communication to establish the communication link with the first network device comprises:
receiving the initiating communication to establish the communication link with the second network device according to a near-field communication protocol when the first network device is within range of the second network device.

22. The method of claim 18, wherein receiving the initiating communication to establish the communication link with the first network device comprises:
receiving the initiating communication to establish the communication link with the second network device according to a non-near-field communication protocol, the non-near-field communication protocol comprising one or more of: a WLAN-based communication protocol, or a WWAN-based communication protocol.

23. The method of claim 17, wherein the property belonging to the second party comprises one of: a hotel room, a vehicle, a parking meter, an air-plane seat, a theater, a locker, or another time-accessible good or service.

24. The method of claim 17, wherein the request previously sent to the peer-to-peer system comprises a transaction request communicated to one or more network devices, of the peer-to-peer system, maintaining transaction ledger data for commercial transactions on the peer-to-peer system, the one or more network devices maintaining the transaction ledger data configured to record the transfer of the required number of commercial-valued credits included in the request to the second party associated with the second network device.

25. The method of claim 17, wherein the required number of commercial-valued credits included in the request comprises one or more of: data representative of a required number of Bitcoins, or data representative of a required number of altcoins.

26. A mobile device comprising:
one or more processors; and
storage media comprising computer instructions that, when executed on the one or more processors, cause operations comprising:
exchanging, by the mobile device associated with a property belonging to a second party, one or more communications with another network device associated with a first party, wherein the other mobile device is associated with a first network address and with a first private-public digital key pair, and wherein the mobile device is associated with a second network address and a second private-public digital key pair; and
determining at the mobile device, based on the one or more communications exchanged with the other mobile device and based on a request previously sent by the other mobile device to a peer-to-peer system comprising at least the mobile device and the other mobile device, whether to provide the first party associated with the other mobile device access to the property, wherein the request sent to the peer-to-peer system is processed with the private key of the other mobile device and comprises payment data representative of a required number of commercial-valued credits to transfer to the second party associated with the mobile device, the request further comprising time data representative of a requested starting time and time duration at which use of the property by the first party associated with the other mobile device is to occur.

27. The mobile device of claim 26, wherein exchanging the one or more communications sent by the other network device comprises:
receiving an initiating communication to establish a communication link with the other mobile device;
transmitting to the other mobile device, by the mobile device, a message comprising a challenge; and
receiving at the mobile device a reply message, transmitted form the other network device, responsive to the challenge, the reply message processed with the private key of the other mobile device.

28. The mobile device of claim 27, wherein determining whether to provide the first party access to the property comprises:
providing the first party with access to the property in response to a determination that the required number of commercial-valued credits was transferred to the second party associated with the mobile device and that the reply message decrypted with the public key of the other mobile device includes a proper response to the challenge.

29. The mobile device of claim 28, wherein providing the first party with access to the property comprises:
sending by the mobile device a signal to unlock a lock that is restricting access to the property.

30. The mobile device of claim 27, wherein receiving the initiating communication to establish the communication link with the other mobile device comprises:
receiving the initiating communication to establish the communication link with the mobile device according to a near-field communication protocol when the other mobile device is within range of the mobile device.
